(19) United States
(12) Patent Application Publication
(10) Pub. No.: US 2025/0001693 A1
(43) Pub. Date: Jan. 2, 2025

(54) A METHOD OF PRODUCING A COMPONENT, AND THE COMPONENT ITSELF

(71) Applicant: KUMOVIS GMBH, München (DE)

(72) Inventors: Sebastian PAMMER, München (DE); Stefan LEONHARDT, München (DE); Yannick KRIEGER, München (DE); Arnaud BRUYAS, München (DE)

(21) Appl. No.: 18/708,033

(22) PCT Filed: Nov. 9, 2022
(86) PCT No.: PCT/EP2022/081374

§ 371 Date: May 7, 2024

(30) Foreign Application Priority Data
Nov. 15, 2021 (DE) 10 2021 129 750.8

(51) Int. Cl. B29C 64/386; B29C 64/118; B29C 64/40; B33Y 50/00; B33Y 70/00

(52) U.S. Cl. CPC B29C 64/386; B29C 64/118; B29C 64/40; B33Y 50/00; B33Y 70/00

(57) ABSTRACT

The present invention relates to a method of producing a component by means of an additive production method, including at least the following steps: —a production plan for the component is generated from digital data; —the component is analyzed regarding its structure and/or its production parameters in respect of the temperature in the component during production; and —a supplementary structure is added to the component at those places where the analysis reveals that the structure and/or the production parameters would result in an inhomogeneous temperature distribution during production. The present invention further relates to a component produced by means of an additive production method.

The present invention relates to a method of producing a component by means of an additive production method as well as to a component produced by means of an additive production method. In particular, the component may be a component of a medical product or the medical product itself.

Additive or generic manufacturing methods (also referred to as 3D printing methods) have become increasingly important in recent decades due to technical progress and will continue to do so increasingly in the future.

In the context of 3D printing of materials in general and of plastics in particular, e.g. especially for medical applications (e.g. for implants), especially the currently achievable component quality (warpage, tolerances, strength, toughness, etc.) as well as specific component properties (such as microstructure or surface properties) are increasingly in the focus of many scientific investigations.

3D printing processes are already known from the prior art, also in connection with medical products, in particular implants.

For example, a 3D printing device, in particular an FFF printing device, which comprises at least one print head unit is already known from DE 10 2015 111 504 A1, wherein the print head unit is provided in at least one operating state for melting a printing material formed at least in part by high-performance plastics, in particular a high-performance thermoplastic material.

Moreover, in EP 3 173 233 A1, a three-dimensional manufacturing apparatus is disclosed comprising a processing chamber heated by a processing chamber heating unit provided for this purpose.

Further, U.S. Pat. No. 6,722,872 B1 discloses a three-dimensional modeling apparatus provided for building three-dimensional objects within a heated building chamber.

Furthermore, US 2015/110911 A1 shows an environment monitoring or control unit which is used, for example, as an interface in additive manufacturing technologies to their respective environments.

Incidentally, WO 2016/063198 A1 shows a method and an apparatus for producing three-dimensional objects by “Fused Deposition Modeling,” wherein the production apparatus comprises radiation heating elements that can heat a surface of the object to be fabricated that is exposed to them.

From WO 2017/108477 A1, a method of producing a three-dimensional object using a “Fused Deposition Modeling” printer can further be gathered.

It is the object of the present invention to further develop a method of producing a component by means of an additive production method as well as a component produced by means of an additive production method of the aforementioned in an advantageous manner, in particular to the effect that the manufacturing accuracy and dimensional accuracy of the components can be improved.

This object is achieved according to the invention by a method of producing a component by means of an additive production method having the features of claim 1. According to this, it is provided that the method of producing a component by means of an additive production method comprises at least the following steps:
a production plan for the component is generated from digital data;
the component is analyzed regarding its structure and/or its production parameters in respect of the temperature in the component during production; and
a supplementary structure is added to the component at those places where the analysis reveals that the structure and/or the production parameters would result in an inhomogeneous temperature distribution during production.

The invention is based on the fundamental idea of improving the temperature management in the component and thus the process stability in the additive manufacturing of components.

The individualized supplementary structures can be used to manufacture components with improved mechanical properties and at the same time with optimized surface quality. When generating the functional supplementary structures, the cross-sectional areas in the component geometry and/or the process parameters are used to design the supplementary structures in such a way that the additive manufacturing process is adapted in the individual layers and thus the temperature distribution in the component can be influenced during the manufacturing process. In addition, the supplementary structures can be used to influence the manufacturing process of additive manufacturing (e.g. optimization of the volume flow by keeping the extrusion rate as constant as possible during additive manufacturing). This can be used to advantage, for example, in the printing of high-performance plastics (used, for example, in medical technology (implants, instruments), aerospace, automotive, . . . ), and here especially also in printing semi-crystalline plastic variants. Compared to conventional support structures, the focus of the functional supplementary structures described is not on the purely geometric stabilization of the component during the printing process, but on temperature management in the component and thus on the process stability of the additive manufacturing process.

In particular, it can be provided that the additive production method is a Fused Deposition Modeling (FDM) method or a Fused Layer Modeling (FLM) method or a Fused Filament Fabrication (FFF) method. These methods allow to reliably produce components, especially components for medical applications. The starting point can be, for example, an STL/STEP/OBJ/generic CAD file. Said file is first oriented in a process-optimizing manner. Taking into account geometric and process-relevant boundary conditions (cross-sectional areas, overhangs, building times per layer, material, process parameters, etc.), the component is aligned relative to the building platform or the printing direction. Subsequently, the component can be analyzed with respect to its cross-sectional areas parallel to the building platform and/or with respect to the printing process parameters. According to this analysis, functional supplementary structures are generated which significantly improve the temperature management during the printing process.

One aim of the design process for the functional supplementary structures can be to “homogenize” the temperature throughout the component in order to achieve, for example, improved mechanical properties or reduced warpage in the component.

The supplementary structures also make it possible to additively manufacture components with a filament discharge (volume flow) that is as constant as possible, which has a very beneficial effect on melt formation in the nozzle, especially in extrusion processes such as the FLM/FFF methods.

Objectives of the design process for the functional supplementary structures may also include, for example, a section-by-section adaptation of the mechanical properties in the component (e.g. through different crystallization rates in the case of semi-crystalline polymers), the creation of hot spots in the component (e.g. to activate additives in the material) or the avoidance of heat accumulation in the component (e.g. to prevent the overheating of heat-sensitive additives in the material (e.g. pharmaceutical admixtures)).

Furthermore, it is conceivable that the supplementary structure is generated by a modification the original component geometry.

It is also conceivable that the supplementary structure is generated by the addition of at least one separate geometrical body.

The supplementary structures can be realized by a modification of the original component geometry or by the generation of additional separate geometrical bodies. The functional supplementary structures can be realized, for example, as thin walls (e.g. connecting separated cross-sectional areas to create a coherent cross-sectional area), as scaffolding or framework structures, porous structures and so on, and they can take over/integrate the functionality of conventional support structures (support of undercut geometries, stabilization of the component, bed adhesion, . . . ).

It is also possible that the supplementary structure is formed by a material which differs from that of the component. This can be done, for example, by 2K printing or 3K printing.

It is also possible to generate a predetermined breaking point between the component and the supplementary structure. Easy removal of the supplementary structures is another design goal, which can be achieved by integrating targeted predetermined breaking points or by integrating structures that are easy to remove (e.g. porous structures).

The material of the component may be or comprise a semi-crystalline polymer. For example, the use of PEEK (polyetheretherketone) is conceivable.

In particular, it is conceivable to use a medically compatible plastic and/or at least one plastic that can be resorbed by the human or animal body. These materials are of interest for a large number of applications for implants, so that their use in the context of the present invention is particularly advantageous. In addition to the aforementioned material PEEK, medically compatible plastics can comprise or be, for example, PEKK (polyetherketoneketone), PAEK (polyaryletherketone), PEI (polyetherimide) or PPSU (polyphenylsulfone), whereas plastics that can be resorbed by the human or animal body can comprise, for example, PCL (polycaprolactone), PDO (poly-p-dioxanone), PLLA (poly-L-lactide), PDLA (poly-D-lactide), PGA (poly glycolic acid) or PGLA (polylactide-co-glycolide).

It can also be provided that the supplementary structure is used as a reinforcement and/or stabilization structure for the cooling process of the component. In addition, the supplementary structures can also be used as a mechanical stiffening of the manufactured component in order to prevent/minimize distortion in the component. During the production of the component, large temperature gradients in the component occur in the cooling process of the plastic melt, resulting in inhomogeneous shrinkage of the component (especially when cooling from the melt temperature to the glass transition temperature of the material). Depending on the geometry and the manufacturing process, this can lead to distortion in the component. This distortion can be prevented/minimized by specifically placed stiffening structures. In particular, the supplementary structures can be designed such that the shrinkage of the material in the supplementary structures compensates for the shrinkage of the material in the component, thus minimizing distortion of the component.

Furthermore, it is conceivable that at least the addition of the supplementary structure is done semi-automatically or automatically.

Furthermore, the present invention relates to a component. According to this, it is provided that component is produced by means of an additive production method, in particular by means of a production method as described above, wherein the component comprises at least one supplementary structure.

In particular, the component may be a component of a medical device or the medical device itself.

Further details and advantages of the invention shall now be explained on the basis of an exemplary embodiment shown in more detail in the drawing.

In the Figures:

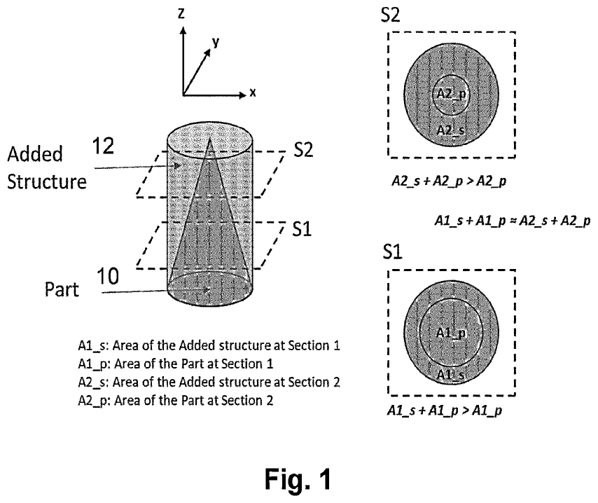

FIG. 1 shows a schematic representation of a supplementary structure generated in an exemplary embodiment of the method according to the invention for a component according to the invention, in which the supplementary structure serves to unify the cross-sectional area per layer;

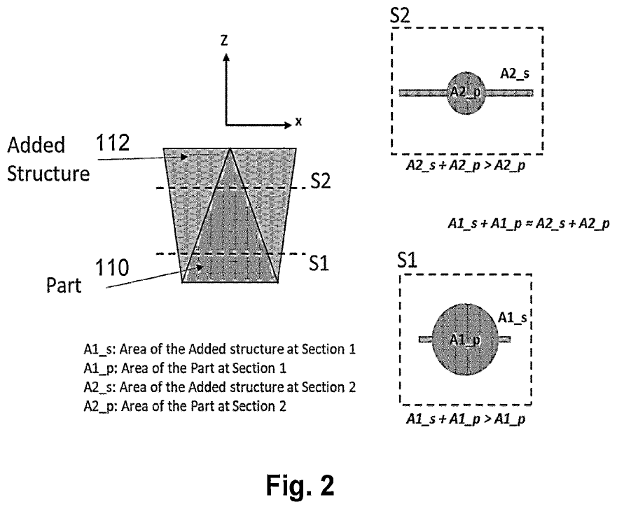

FIG. 2 shows a schematic representation of a supplementary structure for rough adjustment of the cross-sectional area per layer and unification of the print head in the layers for a further exemplary embodiment of the method according to the invention for a component according to the invention; and

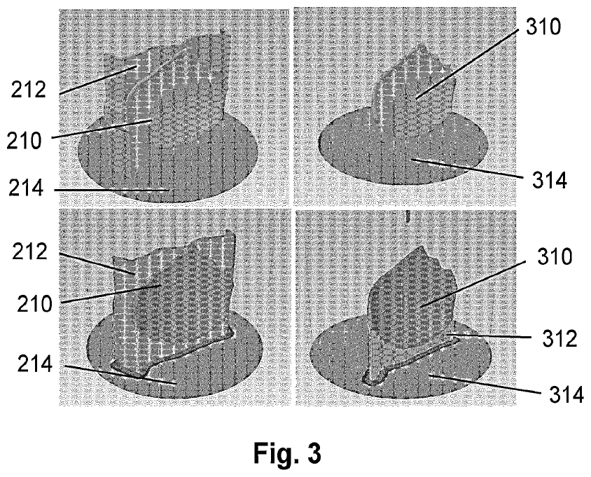

FIG. 3 shows an exemplary embodiment of a component according to the invention in the form of a cranial implant having a functional supplementary structure according to an exemplary embodiment of the method according to the invention, in comparison with an implant according to the previous standard.

FIG. 1 shows a schematic representation of an exemplary embodiment of a component 10 according to the invention.

The component 10 is provided here with a supplementary structure 12. The supplementary structure 12 is generated by means of an exemplary embodiment of the method according to the invention.

Here, the supplementary structure 12 serves to unify the cross-sectional area per layer, as will be described below.

In this example, the component 10 has the shape of a cone. If the component 10 were to be built up in the classic manner, i.e. layer by layer, there would be a risk, especially in the area of the sectional plane S2, which has a significantly smaller cross-sectional area than the cross-sectional area in the area S1, that faster cooling and problems with dimensional accuracy could occur during production.

This is prevented by the addition of the supplementary structure 12.

In the sectional plane S1, A1_s denotes the cross-sectional area of the supplementary structure 12 in area S1 and A1_p denotes the cross-sectional area of the actual component 10.

In the sectional plane S2, A2_s denotes the cross-sectional area of the supplementary structure 12 in area S2 and A2_p denoted the cross-sectional area of the actual component 10.

Due to the supplementary structure 12, the cumulative cross-sectional area of supplementary structure 12 and component 10 is almost identical or identical when the component 10 is manufactured, which means that the temperature distribution and also the cooling behavior is essentially identical.

FIG. 2 shows a similar component 110, which is also an exemplary embodiment of the present invention. In FIG. 2, comparable or identical features are marked with the same reference sign or a reference sign increased by the value 100.

FIG. 3 shows on the left side an exemplary embodiment of a component 210 according to the invention in the form of a cranial implant including a functional supplementary structure according to an exemplary embodiment of the method according to the invention. In comparison to this, an implant 310 according to the previous standard in additive manufacturing methods is shown on the right in FIG. 3.

The component 210 is provided with a supplementary structure 212 and is also connected thereto. These are generated in common on the substrate 214 during the additive manufacturing process. Here, the supplementary structure 212 ensures that the component 210 is connected to the supplementary structure 212 at all edges. This ensures that the component 210 has a homogeneous temperature distribution during manufacturing and also during the cooling process.

In contrast, the supplementary structure 312 is missing on the component 310, particularly in the upper part, i.e. the part facing away from substrate 314. Here, especially in the cooling phase, the component 310 will cool down faster than in the area facing the substrate 314. The support structure 312 additionally amplifies this effect and any temperature gradients, so that without countermeasures such as additional tempering, warpage of the first-cooling structures of the component can occur compared to the slow-cooling structures.

The production method of the component 10 or 110 or 210 can be described approximately as follows:

The method of producing a component 10, 110, 210 by means of an additive production method comprises at least the following steps:
a production plan for the component (10, 110, 210) is generated from digital data;
the component (10, 110, 210) is analyzed regarding its structure and/or its production parameters in respect of the temperature in the component (10, 110, 210) during production; and
a supplementary structure (12, 112, 212) is added to the component (10, 110, 210) at those places where the analysis reveals that the structure and/or the production parameters would result in an inhomogeneous temperature distribution during production.

The production method may be a fused deposition modeling (FDM) method or a fused layer modeling (FLM) method or a fused filament fabrication (FFF) method.

The supplementary structure 12, 112, 212 can be generated by a modification of the original component geometry.

However, it is also possible that the supplementary structure is generated by the addition of at least one separate geometrical body.

The supplementary structure may be formed by a material which differs from that of the component.

Furthermore, a predetermined breaking point may be generated between the component and the supplementary structure.

The material of the component 10, 110, 210 may be or comprise a semi-crystalline polymer. In the exemplary embodiments shown in FIG. 1 to FIG. 3, said material is PEEK.

The supplementary structure 12, 112, 212 serves as a reinforcement and/or stabilization structure for the cooling process of the component.

The addition of the supplementary structure 12, 112, 212 is done semi-automatically or automatically.

The advantages of the method and the component 10, 110, 210 obtained by the method can be described as follows:

It is a possibility to improve the temperature management in the component 10, 110, 210 and thus the process stability in the additive manufacturing of components, especially in FLM/FFF methods (3D printing), which is achieved by printing functionalized supplementary structures in, on and around the component.

The individualized supplementary structures allow to manufacture components—especially also from semi-crystalline plastics—with improved mechanical properties and at the same time with optimized surface quality.

When generating the functional supplementary structures, the cross-sectional areas in the component geometry and/or the FFF process parameters are used to design the supplementary structures in such a way that the FFF printing process is adapted in the individual layers and thus the temperature distribution in the component can be influenced during the printing process.

In addition, the supplementary structures can be used to influence the extrusion process during FLM/FFF (e.g. optimization of the volume flow by keeping the extrusion rate as constant as possible). This can be advantageously used, for example, in the printing of high-performance plastics (used, for example, in medical technology (implants, instruments), aerospace, automotive, . . . ) and here especially also when printing semi-crystalline plastic variants.

Compared to conventional support structures, the focus of the described functional supplementary structures is not on the purely geometric stabilization of the component during the printing process, but on the temperature management in the component and thus on the process stability of the additive manufacturing process.

In addition to the method described here for generating functional supplementary structures geometrically optimized for each layer, speed adaptation depending on the cross-section can also be performed in the areas of the supplementary structures in the slicing scheme (G-code generation).

The starting point is, for example, an STL/STEP/OBJ/generic CAD file.

This file is initially oriented in a process-optimizing manner.

Taking into account geometric and process-relevant boundary conditions (cross-sectional areas, overhangs, building times per layer, material, process parameters, etc.), the component is oriented relative to the building platform or the print direction.

Subsequently, the component is analyzed with regard to its cross-sectional areas parallel to the building platform and/or with regard to the printing process parameters. According to this analysis, functional supplementary structures are generated which significantly improve the temperature management during the printing process.

One objective of the design process for the functional supplementary structures according to the present invention may be to “homogenize” the temperature in the entire component 10, 110, 210 in order to achieve, for example, improved mechanical properties or reduced warpage in the component 10, 110, 210.

The supplementary structures 12, 112, 212 also make it possible to additively manufacture components 10, 110, 210 with a filament discharge (volume flow) that is as constant as possible, which has a very beneficial effect on the melt formation in the nozzle, especially in extrusion processes such as FLM/FFF methods.

Objectives of the design process for the functional supplementary structures can also include, for example, a section-by-section adaptation of the mechanical properties in the component (e.g. through different crystallization rates in the case of semi-crystalline polymers), the creation of hot spots in the component (e.g. to activate additives in the material) or the avoidance of heat accumulation in the component (e.g. to prevent the overheating of heat-sensitive additives in the material (e.g. pharmaceutical admixtures)).

The supplementary structures can be realized by a modification of the original component geometry or by the generation of additional separate geometrical bodies. The functional supplementary structures can be realized, for example, as thin walls (e.g. connecting separated cross-sectional areas to create a coherent cross-sectional area), as scaffolding or framework structures, porous structures and so on, and they can take over/integrate the functionality of conventional support structures (support of undercut geometries, stabilization of the component, bed adhesion, . . . ).

Easy removal of the supplementary structures is another design goal, which can be achieved by integrating targeted predetermined breaking points or by integrating easily removable structures (e.g. porous structures).

The supplementary structures can optionally be made of a different material (e.g. 2K or 3K printing).

By a fine discretization in z-direction (see e.g. FIG. 1 and FIG. 2) during the analysis of the cross-sectional geometry, functional supplementary structures can be generated in such a way that the total cross-section per layer is kept almost constant over the entire component. However, advantages with respect to process control/stability can already be achieved with coarser discretization. Therefore, an exact “homogenization” of the cross section may be aimed at, but is not a mandatory requirement for the method.

In addition, the dynamic behavior of the print head during additive manufacturing (path planning) can optionally be taken into account when generating the supplementary structures in order to be able to influence the times per layer/component layer in this way.

What is more, the thermal characteristics of the printing process and of the extruded material can be taken into account in the generation of the supplementary structures (e.g. inclusion of finite element approaches in the calculation of the supplementary structure geometry) in order to evaluate the energy input into the component even more concretely.

A partial or complete automation of the design process for the functional supplementary structures is advantageous and possible.

An example of a medical application where excellent mechanical specific values have to be combined with good surface properties are individualized cranial implants (cf. FIG. 3, component 210). These can be printed with semi-crystalline polymers (e.g. PEEK) by the printing process in combination with frame-like functional supplementary structures in such a way that the temperature in the layers is “homogenized” across the component and high mechanical strength, good surface quality and minimized geometric distortion can thus be achieved.

The material for component and/or supplementary structure can be a medically compatible plastic and/or at least one plastic that is absorbable by the human or animal body. These materials are of interest for a large number of applications for implants, so that their use in the context of the present invention is particularly advantageous. In addition to the aforementioned material PEEK, medically compatible plastics can comprise or be, for example, PEKK (polyetherketoneketone), PAEK (polyaryletherketone), PEI (polyetherimide) or PPSU (polyphenylsulfone), whereas plastics that can be resorbed by the human or animal body can comprise, for example, PCL (polycaprolactone), PDO (poly-p-dioxanone), PLLA (poly-L-lactide), PDLA (poly-D-lactide), PGA (poly glycolic acid) or PGLA (polylactide-co-glycolide).

Additionally, the supplementary structures may be implemented such that, in addition to the primary function described above, portions of the supplementary structures are used for downstream QA processes. In particular, the supplementary structures can be designed in such a way that, for example, test specimens can be taken from them for mechanical tests (e.g. tensile tests according to ISO 527 or bending tests according to ISO 178 or others) or, for example, test specimens for biological tests (e.g. chemical characterization according to ISO 10993-18 or cytotoxic tests according to ISO 10993-5 or others). Thus, for each manufactured component, one or more test tokens are available with which the manufacturing process can be characterized.

In addition, the supplementary structures can also serve as mechanical reinforcement of the manufactured component to prevent/minimize distortion in the component. During the production of the component, large temperature gradients in the component occur in the cooling process of the plastic melt, resulting in inhomogeneous shrinkage of the component (especially when cooling down from the melt temperature to the glass transition temperature of the material). Depending on the geometry and the manufacturing process, this can lead to distortion in the component. This distortion can be prevented/minimized by specifically placed stiffening structures. In particular, the supplementary structures can be designed in such a way that the shrinkage of the material in the supplementary structures compensates for the shrinkage of the material in the component, thus minimizing distortion of the component.

The concept of the functional supplementary structures can also be applied to other additive manufacturing processes in addition to FLM/FFF.

### REFERENCE SIGNS

10 component
12 supplementary structure
14 substrate
110 component
112 supplementary structure
114 substrate
210 component
212 supplementary structure
214 substrate
310 component
312 supplementary structure
314 substrate
S1 sectional plane 1
S2 sectional plane 2
A1_s cross-sectional area of the supplementary structure in sectional plane 1
A1_p cross-sectional area of the component in sectional plane 1
A2_s cross-sectional area of the supplementary structure in sectional plane 2
A2_p cross-sectional area of the component in sectional plane 2

1. A method of producing a component by means of an additive production method, including at least the following steps:
a production plan for the component is generated from digital data;
the component is analyzed regarding its structure and/or its production parameters in respect of the temperature in the component during production; and
a supplementary structure is added to the component at those places where the analysis reveals that the structure and/or the production parameters would result in an inhomogeneous temperature distribution during production.

2. The method according to claim 1,
wherein
the additive production method is a Fused Deposition Modeling (FDM) method or a Fused Layer Modeling (FLM) method or a Fused Filament Fabrication (FFF) method.

3. The method according to claim 2,
wherein
the supplementary structure is generated by a modification of the original component geometry.

4. The method according to claim 1,
wherein
the supplementary structure is generated by the addition of at least one separate geometrical body.

5. The method according to claim 4,
wherein
the supplementary structure is formed by a material which differs from that of the component.

6. The method according to claim 1,
wherein
a predetermined breaking point is generated between the component and the supplementary structure.

7. The method according to claim 5,
wherein
the material of the component is or comprises a semi-crystalline polymer.

8. The method according to claim 1,
wherein
the supplementary structure is used as a reinforcement and/or stabilization structure for the cooling process of the component.

9. The method according to claim 4,
wherein
at least the addition of the supplementary structure is done semi-automatically or automatically.

10. A component produced by means of an additive production method including by means of a production method according to claim 1, wherein the component comprises at least one supplementary structure.
